(19) United States
(12) Patent Application Publication
(10) Pub. No.: US 2009/0289238 A1
(43) Pub. Date: Nov. 26, 2009

(54) Horizontal universal frame lift system

(76) Inventor: Ronald Norris Olson, St. George, UT (US)

Correspondence Address: Ronald Norris Olson, 486 N. 2310 E., St. George, UT, 84790, US

(21) Appl. No.: 12/229,095

(22) Filed: Aug. 19, 2008

Related U.S. Application Data
(60) Provisional application No. 60/965,479, filed on Aug. 21, 2007.

(51) Int. Cl. B66F 7/12

(52) U.S. Cl. 254/89 R

(57) ABSTRACT

The Horizontal Universal Frame Lift System is compromised of four telescoping posts located in each corner of a vehicle or trailer on which a universal metal frame is mounted to each of the four corners. The telescoping posts are raised and/or lowered with electronic actuators and drive screws. An electronic control module activates the actuators with the use of a toggle switch or hand held remote transmitter. When the actuators are activated with the toggle switch or remote control it raises and/or lowers the frame to the desired position. The frame itself mounts on the top inside of the cargo area of vehicle or trailer and as such a person may also mount any type of cover onto the frame which would also be raised or lowered with the frame.

### CROSS-REFERENCE TO RELATED APPLICATIONS

Not applicable.

### STATEMENT REGARDING FEDERALLY SPONSORED

Not applicable.

### BACKGROUND OF THE INVENTION

The invention basically came out of the frustration of owning a pickup with a “Tonneau” cover. Because of the limitations of the cover only opening from the back in a tilt manner it would not allow a person to haul larger items in the cargo area. The restrictions were that one could only load items that were not larger in height than the sides of the cargo area unless they would have to open the cover and use ropes or expandable tie downs so the cover itself would not be damaged. After many different applications it was determined that the current invention is the most practical and cost effective way to at least double the cargo volume capacity. Because the entire cover can be raised, one can place larger cargo closer to the front of the cargo area to allow more capacity and makes the vehicle more stable to drive as the weight of the cargo is more evenly distributed.

Once the lift system was designed and functional it was then discovered that it does not have to be limited to just pickups. The same system can be used with trailers and larger vehicles. Not only that but one could mount tool/service boxes on the frame which could also be used whenever the frame was raised.

### BRIEF SUMMARY OF THE INVENTION

The Horizontal Universal Frame Lift System's adjustable frame of this invention is extremely universal in its applications. Although the Horizontal Universal Frame Lift System's adjustable frame was designed to be used independently it is not restricted as to what may be mounted onto the adjustable frame itself. The other systems are limited in their use as they are designed for a specific purpose ie. lifting Tonneau covers, hard shell covers etc. This invention is designed to raise a “adjustable frame” to a desired height or maximum height above vehicles and/or trailers sides of its cargo area which makes it universal and versatile in its application.

The invention, the Horizontal Universal Frame Lift System's adjustable frame itself may be used a tool to assist an individual in positioning the cargo in the cargo area of said vehicle and/or trailer by utilizing the frames lifting mechanism to be able to position heavy or bulky loads closer to the front of the cargo area which allows the cargo to be better protected.

The invention, the Horizontal Universal Frame Lift System's adjustable frame itself may be used a tool to assist an individual in positioning the cargo in the cargo area of said vehicle and/or trailer by utilizing the frames lifting mechanism to be able to position heavy or bulky loads closer to the front of the cargo area which allows the cargo to be better placed in the cargo area to equalize the cargo over the rear axles making it safer to haul said cargo.

The frame of the Horizontal Universal Frame Lift System's adjustable frame also serves many functions. Because of the unique design of the adjustable frame many different items may be mounted to the frame itself. Some of these items which may be attached and/or mounted to the frame include but are not limited to the following: hard shell Tonneau covers, fiber glass covers, plastic covers, vinyl covers, canvas covers, metal covers, wooden covers, camper shells, hard cover sides, soft cover sides, tool boxes on sides and/or front of frame, service boxes etc. Also because of the Horizontal Universal Frame Lift System's adjustable frame unique design with any of the above mentioned items and or other items which may be mounted to the frame, there is no restriction as to the functions of each of the items. In the specific cases of Tonneau covers and/or camper shells as an example, the item is fully functional in any upward or downward position. This is a tremendous advantage when loading cargo areas in that covers and or shells may be elevated out of the way for greater cargo capacity and ease of loading heavy, large or bulky items.

Another embodiment(s) (four) which consist of telescoping posts which are mounted to each corner of vehicle/trailer bed of cargo area.

Another embodiment(s) (four) which consist of Actuators will be used. These actuators are mounted in each of the telescoping posts and are synchronized so the adjustable frame will lift evenly.

Another embodiment(s) (four or eight) drive screw(s) of each of the actuators propel the telescoping posts in an upward and/or downward direction.

Another embodiment(s) (four) which consist of mounting bracket to secure each of the four corner telescoping posts.

Another embodiment control module which the four actuators are electrically wired to which provide the electricity to the actuators. The control module is wired to the electrical system of said vehicle and/or trailer.

Another embodiment(s) a small hand held wireless remote controller and/or toggle switch which activates the actuators.

### BRIEF DESCRIPTION OF THE DRAWINGS

FIG. 1 is a perspective view of the cargo area of vehicle and/or trailer, and the Adjustable Frame of the Horizontal Universal Frame Lift System including the embodiments of the Control Module and four Telescoping Posts all within the view of the cargo area of vehicle and/or trailer.

FIG. 2 is an exploded view which includes but not limited to one of the four telescoping posts, another embodiment of the actuator, drive screws and other relative components.

FIG. 3 is a exploded partial view of the inside left rear of cargo area which includes but not limited to one of the four telescoping posts, actuator, drive screws, Top Mounting Bracket and other relative components.

FIG. 4 is an exploded view the rear left side of cargo area to include but not limited to Top Mounting Bracket and Side Mounting Bracket and other relative components.

FIG. 5 is a side view and front view of one of the four Side Mounting Brackets which is bolted to the cargo area of vehicle and/or trailer and mounted to Outside Post of telescoping post.

FIG. 6 is a perspective view of the Adjustable Frame of the Horizontal Universal Frame Lift System including the embodiments of the tool/storage boxes which may be mounted directly to the Adjustable Frame of the Horizontal Universal Frame Lift System.

### DETAILED DESCRIPTION OF THE INVENTION

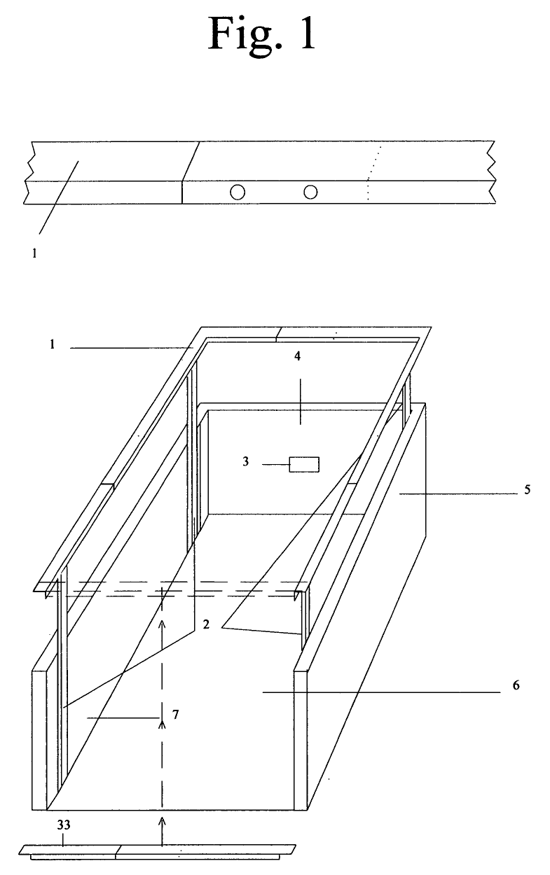

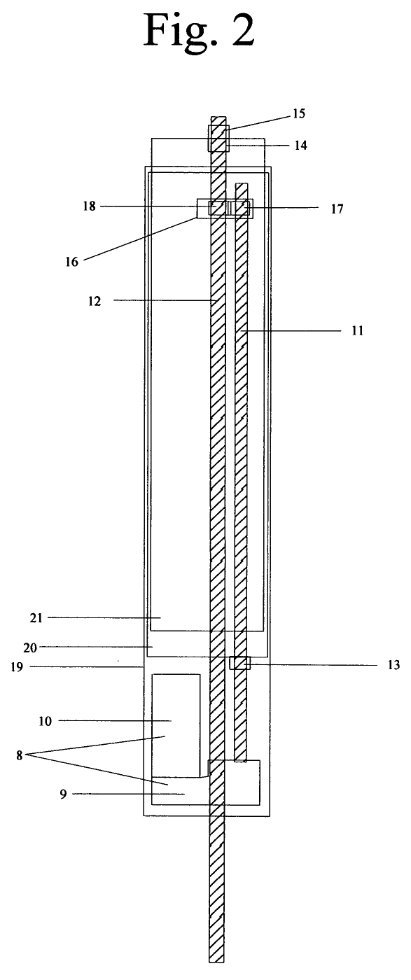

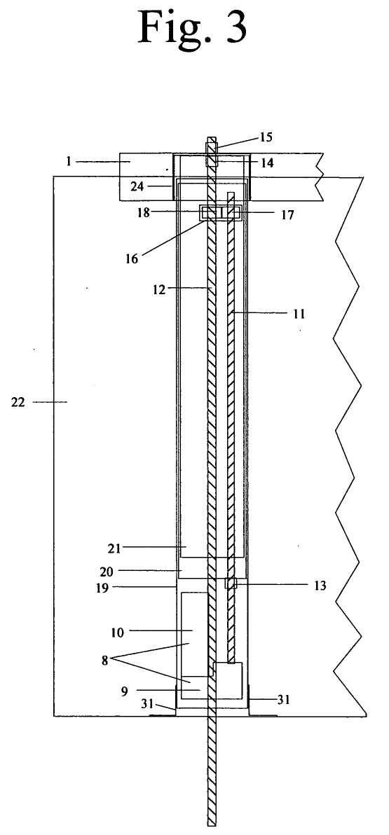

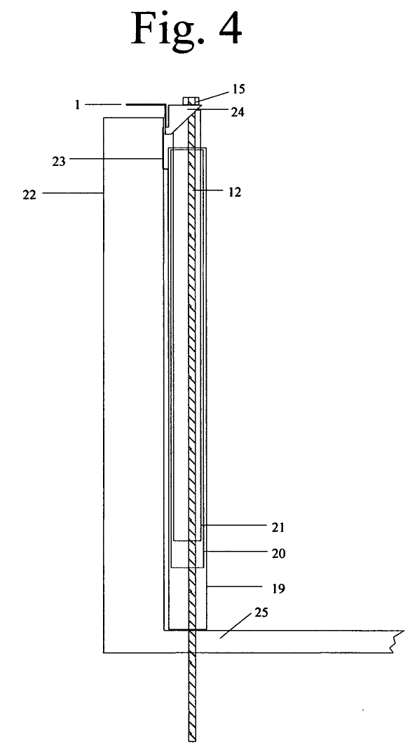

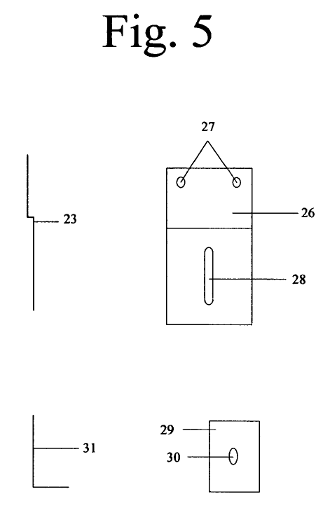

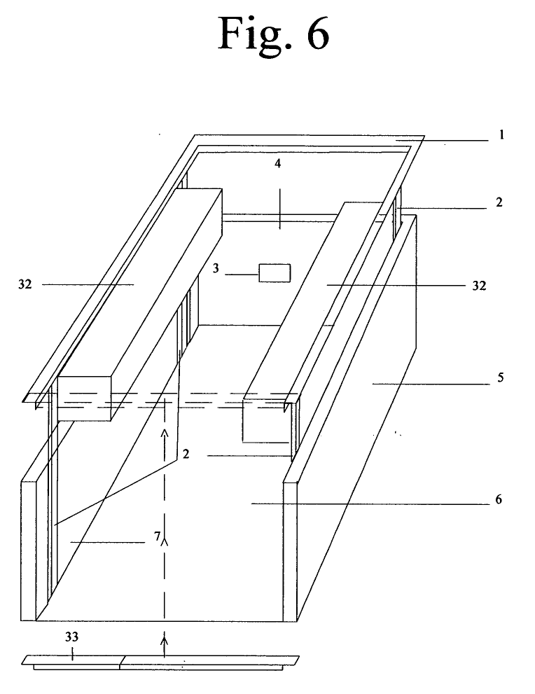

In the following description there will be references made to the attached drawings which are sequentially numbered and labeled FIG. 1, FIG. 2, FIG. 3, FIG. 4, FIG. 5 and FIG. 6. Each figure has several other numbered components which are repeated throughout the drawings. It is to be understood the Adjustable Frame is the primary invention however requires other embodiments to be fully functional. These embodiments are described in detail as to their specific function and purpose. It is also to be understood that due to the different sizes of the vehicle and/or trailer cargo area it is critical the exact size of the Adjustable Frame and the other embodiments need to be adjusted in their size to accommodate those variations which are all relative to the size of vehicle and/or trailer cargo area There fore there are no specific measurements given on the drawings.

The present invention, the Horizontal Universal Frame Lift System's Adjustable Frame is designed to be a universal and multi function lift system which has a variety of uses and embodiments. Due to its universal design the Adjustable Frame may be used with virtually any size vehicle and/or trailer. The universal design allows it to work independently whereas the adjustable flame when elevated to its maximum position with the use of the other embodiments may be used to carry items which are longer than the typical vehicle and/or trailer cargo area such as ladders, plastic pipe, boards etc. The universal design of the Adjustable Frame will also accommodate the installation of virtually any type of vehicle and/or trailer cover.

FIG. 1 is a perspective view of the Adjustable Frame 1, extended in an upwards position showing partial drawings of it's primary components. FIG. 1 shows partial drawings of the telescoping posts, Electronic Control Module 3, Front of vehicle and/or trailer cargo area 4, Right outside of vehicle and/or trailer cargo area 5, Floor and/or bed of vehicle and/or trailer cargo area 6, and left side of vehicle and/or trailer cargo area FIG. 1 also shows exploded view of one of the sides of the Adjustable Frame 1, to depict how the Adjustable Frame 1, itself is adjustable by simply the over lapping of each other to accommodate for the variable sizes of the sides, front, and rear of vehicle and/or trailer cargo area

FIG. 2 is an exploded view of one of the four telescoping posts which are mounted in each corner to the Horizontal Universal Frame Lift System's Adjustable Frame 1, in each corner of vehicle and/or trailer floor or bed. FIG. 2 shows one of the four Actuator Motor and Gear Box 8, mounted in each of the telescoping posts, which is compromised of 12 volt Actuator Motor 10, and Actuator Gear Box 9. The Actuator Motor 10, is wired into the Electronic Control Module 3, in FIG. 1 which receives the 12 volts of electricity directly from the positive and negative sides of the vehicles 12 volt battery in the vehicle. In a situation using the invention in a trailer, the electrical wiring will have to run from towing vehicle. The Electronic Control Module 3, activates the Actuator Motor 10, through a hand held wireless devise and/or by a simple toggle switch and can be positioned at any height. The Electronic Control Module 3, may be programmed to raise the Adjustable Frame 1, to it's total height by depressing the wireless devise up button or toggle switch up button one time and henceforth may be lowered to it's total downward position by depressing wireless devise down button or toggle switch down button one time. The Electronic Control Module 3, may also be programmed to be elevated to any height by depressing and releasing wireless devise up button or toggle switch up button in stages or until it reaches total height. Consequently may be lowered to any position or height after loading cargo area by depressing and releasing wireless devise or toggle switch until lowered to desired position.

To understand how the lifting process takes place refer to FIG. 2 and it's components which operate each of the telescoping posts. Each telescoping post unit is comprised of three separate posts which are the Outside Telescoping Post 19, which encloses the other components, the Middle Telescoping Post 20, and the Inside Telescoping Post 21. The rest of the components compromising the actual lifting mechanisms are inside the Inside Telescoping Post 21, with the exception of the Actuator Motor and Gear Box 8, which are housed in the inside of the Outside Telescoping Post 19. Upon electrically activating the Actuator Motor 10, through the Electronic Control Module 3, by use of wireless devise or toggle switch depressing the upward button, Actuator Motor 10, engages Actuator Gear Box 9, which in turn rotates the Main Drive Screw 11, in a clockwise rotation. The Mounting Nut (1) 13, is permanently fixed to the bottom of the Middle Telescoping Post 20, which causes the Middle Telescoping Post 20, to move in an upward manner as the Main Drive Screw 11, is rotating clockwise. As the Main Drive Screw 11, rotates clockwise it is engaging the Main Gear 17, which is permanently fixed to the top of the Main Drive Screw 11. The Main Drive Screw 11, then meshes and turns the Secondary Gear 18, in a counter clockwise rotation. The Secondary Gear 18, is threaded on the inside with a reversed tread of the Main Drive Screw 11. The Main Gear 17, and Secondary Gear 18, will rotate in opposite directions with Main Gear 17, turning clockwise in upward mode and Secondary Gear 18, turning counter clockwise in upward mode. The Main Gear 17, Main Drive Screw 11, Secondary Gear 18, Secondary Drive Screw 12, are housed and stabilized in the Holding Bracket 16, which allows the gears to be in constant contact with each other and both be stable. As the threaded Secondary Gear 18, is rotating it causes the Secondary Drive Screw 12, to move in an upward direction. The Secondary Drive Screw 12, is mounted to the top of the Inside Telescoping Post 21, with two additional mounting nuts, Mounting Nut 14, and Mounting Nut 15. This mounting process stops the Secondary Drive Screw 12, from rotating which allows the Secondary Drive Screw 12, to move in the upward direction as the Secondary Gear 18, rotates reversibly with the Main Gear 17. The Secondary Drive Screw 12, has a reversed thread from the Main Drive Screw 11, which allows the Secondary Drive Screw 12, to move upwards in the upward mode. This entire process is reversed when depressing the downward button on the wireless devise or toggle switch

The exploded view of FIG. 3 is similar to FIG. 2 other than it shows a front view of the Telescoping Posts along with the Adjustable Frame 1, Partial View of Left rear of vehicle and/or trailer cargo area 22, and Top Mounting Bracket 24.

FIG. 4 exploded view shows the Adjustable Frame 1, being slightly elevated above the left rear of the vehicle and/or trailer cargo area 22. The Top Mounting Bracket 24, is permanently fixed to the Adjustable Frame 1. The Secondary Drive Screw 12, and Inside Telescoping Post 21, are fixed to the Top Mounting Bracket 24, utilizing a compression technique using Mounting Nut 14, and Mounting Nut 15. Mounting Nut 14, is permanently fixed to the top of the Inside Telescoping Post 21, and Secondary Drive Screw 12. The top of Secondary Drive Screw 12, passes through a hole in the center of the Top Mounting Bracket 23, to which Mounting Nut 15, is screwed down on to. The compression between the two upper mounting nuts, Mounting Nut 14, and Mounting Nut 15, allows the Inside Telescoping Post 21, and Secondary Drive Screw 12, to be securely fastened to the Top Mounting Bracket 24. With all of the actions as stated, and the Inside Telescoping Post 21, with Secondary Drive Screw 12, being securely fastened to the Top Mounting Bracket 24, and all of the actions cause the Adjustable Frame 1, to move in an upward or downward direction depending on which button is depressed on the wireless devise and/or simple toggle switch.

FIG. 5 shows a side view and front view of the Side Mounting Bracket 23. The Side Mounting Bracket 23, serve only one purpose which is to secure the Outside Telescoping Post 19, in a stable position to the side of cargo area so the unit may not move either forward, backward or from side to side. The Lower Mounting Bracket(s) 31, serves only one purpose which is to secure the Outside Telescoping Post 19, in a stable position to the floor or bed of vehicle and or trailer.

FIG. 6 is a perspective view very similar to FIG. 1 with the addition of the Optional Tool Boxes 32, being shown.

The invention Horizontal Universal Frame Lift System's Adjustable Frame 1, may be used in conjunction with all or some of the embodiments previously described. It needs to be further understood that some of the embodiments need to be adjusted or changed as each application will warrant. Once again it needs to be emphasized that the Horizontal Universal Frame Lift System's Adjustable Frame 1, can be operated independently with all or some of the embodiments included in the description and drawings. It is to be further understood that all or any of the embodiments may be changed, altered, modified, and/or substituted to achieve the purpose for which the invention has been created. Two brief examples may be while still utilizing the telescoping posts one could use two telescoping posts and one drive screw of the actuator or while utilizing the three telescoping posts with one drive screw of the actuator for the middle post and a cable/chain mechanism to raise the inside post. The changes, alterations, modifications and/or substitutions could be a result of upper or lower limitations or restrictions which would be required to perform the Adjustable Frame 1 lifting functions and purpose.

1. (canceled)

2. The Horizontal Universal Frame Lift System's metal adjustable frame is connected to four telescoping posts mounted in each corner of vehicle and/or trailer cargo area, each of which is compromised of three metal tubes which closely fit inside of each other. These tubes may be rectangular or cylindrical in shape.

3. The Horizontal Universal Frame Lift System's telescoping posts are raised or lowered to desired position by four electronic actuators (one in each post) with drive screw(s) attached to the actuators and two inside posts inside each of the four telescoping posts.

4. (canceled)

5. The Horizontal Universal Frame Lift System's adjustable frame is unique in it's design because it can operate independently or with any type of additional man made or virtually any other manufactured products mounted directly to the adjustable frame.

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)
